(19) United States
(12) Patent Application Publication
(10) Pub. No.: US 2025/0076639 A1
(43) Pub. Date: Mar. 6, 2025

(54) WEARABLE ELECTRONIC DEVICE INCLUDING ANTI-FOG STRUCTURE

(71) Applicant: SAMSUNG ELECTRONICS CO., LTD., Suwon-si (KR)

(72) Inventors: Hyunsoo KIM, Suwon-si (KR); Hongsuk KIM, Suwon-si (KR); Byungkwon KANG, Suwon-si (KR); Soonsang PARK, Suwon-si (KR); Donghyun YEOM, Suwon-si (KR); Chanhyung YOO, Suwon-si (KR); Kwangtai KIM, Suwon-si (KR); Dongchoon HWANG, Suwon-si (KR)

(73) Assignee: SAMSUNG ELECTRONICS CO., LTD., Suwon-si (KR)

(21) Appl. No.: 18/823,049

(22) Filed: Sep. 3, 2024

Related U.S. Application Data
(63) Continuation of application No. PCT/KR2024/013158, filed on Sep. 2, 2024.

(30) Foreign Application Priority Data
Aug. 31, 2023 (KR) 10-2023-0115815
Oct. 20, 2023 (KR) 10-2023-0141415

(51) Int. Cl. G02B 27/00; G02B 7/02; G02B 27/01; G02C 7/08; G02C 11/08

(52) U.S. Cl. CPC G02B 27/0006; G02B 7/028; G02B 27/0172; G02B 27/0176; G02C 11/08; G02B 2027/0154; G02B 2027/0178; G02C 7/081

(57) ABSTRACT

Provided is a wearable electronic device including an anti-fog structure, the wearable electronic device including: a main body portion; a lens module including a lens and a barrel structure, wherein the barrel structure surrounds the lens and is on one surface of the main body portion; and at least one heat source, wherein the barrel structure includes a thermal conductive material thermally connected to the at least one heat source and at least partially extending in a first direction, and wherein the thermal conductive material is configured to transfer heat from the at least one heat source to the lens.

### CROSS-REFERENCE TO RELATED APPLICATIONS

This application is a by-pass continuation application of International Application No. PCT/KR2024/013158, filed on Sep. 2, 2024, which is based on and claims priority to Korean Patent Application No. 10-2023-0115815, filed on Aug. 31, 2023, and Korean Patent Application No. 10-2023-0141415, filed on Oct. 20, 2023, in the Korean Intellectual Property Office, the disclosures of which are incorporated by reference herein in their entireties.

### BACKGROUND

### 1. Field

The disclosure relates to a wearable electronic device including an anti-fog structure.

### 2. Description of Related Art

Electronic devices armored with brand-new functionalities are quickly developing, and with them flourishing, portable terminals or such electronic devices are becoming an important part of people's everyday life. The advance in mobile technology is leading to increasing demand for more compact and lightweight portable terminals, e.g., smartphones, with maximized user portability and convenience along with the need for integrating the parts in a smaller space for higher performance.

Portable terminals such as smartphones are evolving to become lighter and smaller, including in forms wearable on a body part such as a wrist or head. For example, a head-mounted device, smart glasses, a smart watch (or band), a contact lens-type device, a ring-type device, a glove-type device, a shoe-type device, or a clothing-type device may be worn on the user's body. Such body-worn electronic devices are easy to carry and may enhance user accessibility.

A “head-mounted wearable device” is a device worn on the user's head or face, and is a device that projects an image onto the user's retina to view a virtual image in a three-dimensional space. For example, head-mounted wearable devices may be divided into a see-through type that provides augmented reality (AR) and a see-closed type that provides virtual reality (VR). The see-through type head mounted wearable device may be implemented in the form of glasses and may provide the user with, e.g., information, such as information regarding buildings and objects in the space within the user's field of view in the form of images or text. The see-closed type head-mounted wearable device may output independent images to the user's eyes, respectively, and provide the user with content (games, movies, streaming, broadcasting, etc.), which is provided from a mobile communication terminal or an external input, in the form of video or sound to thereby provide an excellent sense of immersion. Further, the head-mounted wearable device may be used to provide mixed reality (MR) or extended reality (XR), which is a combination of augmented reality (AR) and virtual reality (VR).

If a user wearing a head-mounted wearable electronic device enters from a lower-temperature outdoor space to a relatively high-temperature indoor space, e.g., in a cold season like winter, the lens may become foggy.

### SUMMARY

Provided is a wearable electronic device.

According to an aspect of the disclosure, a wearable electronic device includes: a main body portion; a lens module including a lens and a barrel structure, wherein the barrel structure surrounds the lens and is on one surface of the main body portion; and at least one heat source, wherein the barrel structure includes a thermal conductive material thermally connected to the at least one heat source and at least partially extending in a first direction, and wherein the thermal conductive material is configured to transfer heat from the at least one heat source to the lens.

The wearable electronic device may be a video see through device.

The thermal conductive material may be formed by a double injection process with respect to the barrel structure.

The lens module may include a plurality of lenses spaced apart from each other at predetermined intervals along a height direction of the barrel structure, and the thermal conductive material may include a first heat conductive portion extending in the height direction of the barrel structure and configured to transfer the heat to the plurality of lenses.

The thermal conductive material may further include a plurality of second heat conductive portions thermally connected to the first heat conductive portion, wherein the plurality of second heat conductive portions extend in a second direction different from the height direction of the barrel structure and are configured to transfer the heat to the plurality of lenses.

The plurality of second heat conductive portions may be disposed along a circumference of the barrel structure.

The plurality of second heat conductive portions may be inclined with respect to a width direction of the barrel structure.

The plurality of lenses may include: a lens movable in the barrel structure and configured to adjust a diopter; and a fixed lens including a fixed position, the plurality of second heat conductive portions may include a second heat conducting portion corresponding to the movable lens and a second heat conducting portion corresponding to the fixed lens, and the second heat conductive portion corresponding to the movable lens may include a thickness greater than a thickness of the second heat conductive portion corresponding to the fixed lens.

The at least one heat source may be at least one of a heat source inside the lens module or a heat source in the main body portion outside the lens module.

The at least one heat source may be a display and a processor in the main body portion.

The thermal conductive material may be thermally connected to a plurality of heat sources.

The barrel structure may include a barrel and a barrel cover on a rear surface of the barrel.

The barrel cover may include a display seating portion where the display is seated.

The wearable electronic device may further include: a heat dissipation plate adjacent to the at least one heat source and configured to transfer the heat from the at least one heat source to the barrel structure.

The wearable electronic device may further include a printed circuit board, the at least one heat source may be on a surface of the printed circuit board, and the heat may be transferred to the barrel structure through a fastening member connected to a fastening hole formed in the barrel structure.

According to an aspect of the disclosure, a wearable electronic device includes: a main body portion; a lens module including: a plurality of lenses; and a barrel structure, wherein the barrel structure surrounds the plurality of lenses and is on one surface of the main body portion; and at least one heat source, wherein the barrel structure includes a thermal conductive material thermally connected to the at least one heat source and configured to transfer heat from the at least one heat source to the plurality of lenses, and wherein the thermal conductive material includes a first heat conductive portion extending in a first direction and a second heat conductive portion thermally connected to the first heat conductive portion and extending in a second direction different from the first direction.

The wearable electronic device may be a video see through device.

The first heat conductive portion may include a shape extending in the first direction to correspond to at least two lenses among the plurality of lenses, and the second heat conductive portion may include a plurality of second heat conductive portions extending in the second direction from the first heat conductive portion, wherein each of the plurality of second heat conductive portions corresponds to a lens of the plurality of lenses.

A lens of the plurality of lenses may be configured to be movable in the barrel structure and to adjust a diopter, the plurality of second heat conductive portions may include a second heat conductive portion corresponding to the lens that is configured to be moveable and a second heat conductive portion corresponding to a lens of the plurality of lenses with a fixed position, and a thickness of the second heat conductive portion corresponding to the lens that is configured to be moveable may be greater than a thickness of the second heat conductive portion corresponding to the lens with the fixed position.

The at least one heat source may be at least one of a heat source inside the lens module or a heat source in the main body portion outside the lens module.

According to an aspect of the disclosure, a wearable electronic device includes: a main body portion; a lens module includes a lens and a barrel structure, wherein the barrel structure surrounds the lens and is on one surface of the main body portion; and at least one heat source, wherein the barrel structure includes a first heat conductive portion extending in a first direction and a second heat conductive portion thermally connected to the first heat conductive portion and the lens and extending in a second direction different from the first direction, wherein the first heat conductive portion is thermally connected to the at least one heat source, and wherein the barrel structure is configured to transfer heat from the at least one heat source to the lens through the first and the second heat conductive portions.

### BRIEF DESCRIPTION OF THE DRAWINGS

The foregoing and other aspects and features of the present disclosure will be more apparent from the following detailed description taken in conjunction with the accompanying drawings, in which:

FIG. 1 is a block diagram illustrating an electronic device in a network environment according to an embodiment of the disclosure;

FIG. 2 is a view illustrating a wearable electronic device according to an embodiment of the disclosure;

FIG. 3 is a perspective view illustrating a front surface of a wearable electronic device according to an embodiment of the disclosure;

FIG. 4 is a perspective view illustrating a rear surface of a wearable electronic device according to an embodiment of the disclosure;

FIG. 5 is a front view illustrating a rear surface of a wearable electronic device according to an embodiment of the disclosure;

FIG. 6 is a view illustrating a heat transfer system of a wearable electronic device according to an embodiment of the disclosure;

FIG. 7 is a view illustrating a rear surface of a lens module according to an embodiment of the disclosure;

FIG. 8 is a view illustrating a side surface of a lens module according to an embodiment of the disclosure;

FIG. 9A is a view illustrating a state in which a barrel is removed from a lens module according to an embodiment of the disclosure;

FIG. 9B is a view illustrating a lens module having a display mounted thereon according to an embodiment of the disclosure;

FIG. 10A is a view illustrating an arrangement of a lens module and a thermal conductive material according to an embodiment of the disclosure;

FIG. 10B is a view illustrating an arrangement of a lens module and a thermal conductive material according to an embodiment of the disclosure;

FIG. 11 is a view illustrating an arrangement of a lens module and a thermal conductive material according to an embodiment of the disclosure;

FIG. 12 is a view illustrating a lens module having a display further including a heat dissipation plate mounted thereon according to an embodiment of the disclosure; and

FIG. 13 is a view illustrating a coupling relationship between a printed circuit board and a thermal conductive material according to an embodiment of the disclosure.

Throughout the drawings, like reference numerals may be assigned to like parts, components, and/or structures.

### DETAILED DESCRIPTION

The disclosure provides various embodiments for increasing the heat dissipation performance of a head-mounted wearable electronic device having a narrow arrangement space while removing, reducing, and/or preventing fogginess without having a separate heat source.

The following description taken in conjunction with the accompanying drawings may provide an understanding of various exemplary implementations of the disclosure, including claims and their equivalents. The specific embodiments disclosed in the following description entail various specific details to aid understanding, but are regarded as one of various embodiments. Accordingly, it will be understood by those skilled in the art that various changes and modifications may be made to the various implementations described in the disclosure without departing from the scope and spirit of the disclosure. Further, descriptions of well-known functions and configurations may be omitted for clarity and brevity.

The terms and words used in the following description and claims are not limited to the bibliographical meaning, but may be used to clearly and consistently describe an embodiment of the disclosure. Therefore, it will be apparent to those skilled in the art that the following description of various implementations of the disclosure is provided only for the purpose of description, not for the purpose of limiting the disclosure defined as the scope of the claims and equivalent thereto.

The singular forms “a,” “an,” and “the” are intended to include the plural forms as well, unless the context clearly indicates otherwise. Thus, as an example, “a component surface” may be interpreted as including one or more of the surfaces of a component.

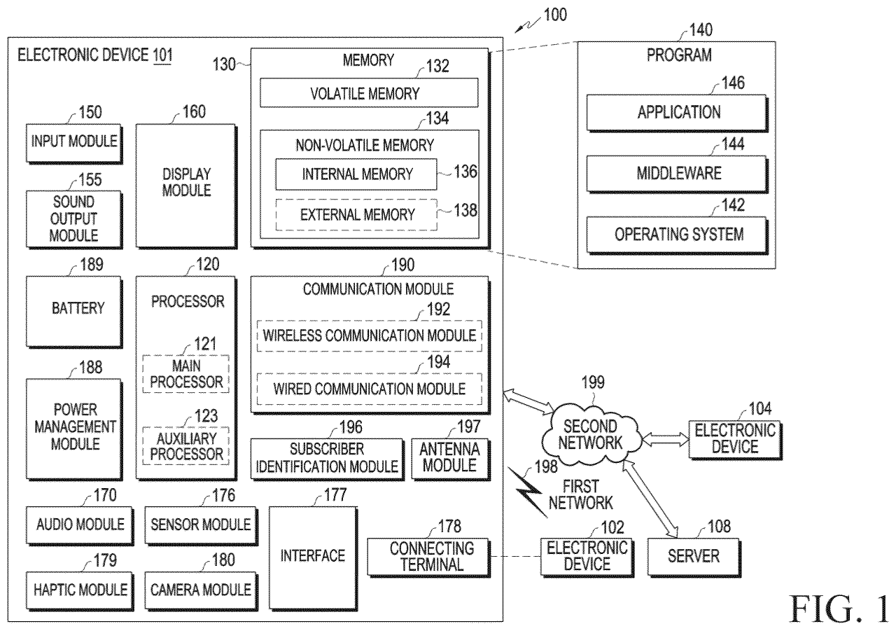

FIG. 1 is a block diagram illustrating an electronic device 101 in a network environment 100 according to an embodiment of the disclosure. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module may include an antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

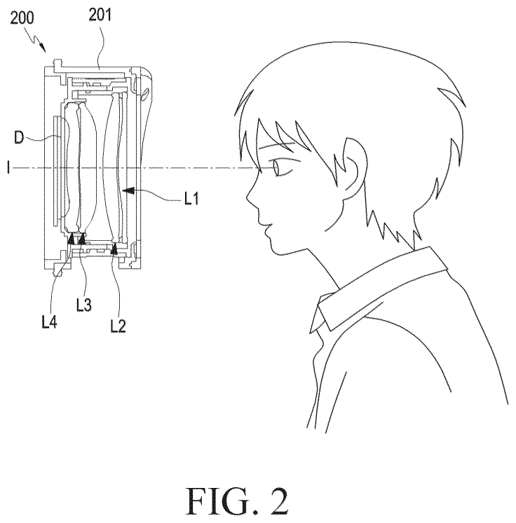

FIG. 2 is a view illustrating a wearable electronic device according to an embodiment of the disclosure.

Referring to FIG. 2, the wearable electronic device 200 (e.g., an electronic device 101 of FIG. 1) may be an electronic device that may be worn on the user's head or face, and the user may visually recognize the surrounding objects or environment even while wearing the wearable electronic device 200. The wearable electronic device 200 may obtain and/or recognize a visual image regarding the environment or an object in the direction in which the wearable electronic device 200 is oriented or the user views using the camera module and receive information about the object or environment from an external electronic device through a network. The wearable electronic device 200 may provide the received object- or environment-related information, in the form of an audio or visual form, to the user. For example, the wearable electronic device 200 may provide the received object-or-environment-related information, in a visual form, to the user through a display member such as a display module. By implementing information about the object or environment in a visual form and combining them with a real image (or video) of the user's ambient environment, the wearable electronic device 200 may implement augmented reality (AR), virtual reality (VR), mixed Reality (MR), and/or extended reality (XR). The display member may output a screen in which the augmented reality object is added to the actual image (or video) of the environment around the user, thereby providing information regarding the surrounding thing or environment to the user.

According to an embodiment, all or some of operations to be executed at the electronic device 101 or wearable electronic device 200 may be executed at one or more of the external electronic devices 102, 104, or 108. For example, if the electronic device 101 or wearable electronic device 200 should perform a function or a service automatically, or in response to a request from a user or another device, the electronic device 101 or wearable electronic device 200, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101 or wearable electronic device 200. The electronic device 101 or wearable electronic device 200 may provide the outcome, with or without further processing of the outcome, as at least part of a reply to the request. For example, the external electronic device 102 may render and transfer, to the electronic device 101 or wearable electronic device 200, content data executed on an application, and the electronic device 101 or wearable electronic device 200 receiving the data may output the content data to a display module. When the electronic device 101 or wearable electronic device 200 detects the user's movement through one or more sensors such as an inertial measurement unit sensor, the processor (e.g., the processor 120 of FIG. 1) of the electronic device 101 or wearable electronic device 200 may correct the rendering data received from the external electronic device 102 based on the movement information and output the same on the display module. Alternatively, when detecting the user's movement through the sensor(s), the processor (e.g., the processor 120 of FIG. 1) of the electronic device 101 or wearable electronic device 200 may transfer the movement information to the external electronic device 102, rendering to update the screen data. According to various embodiments, the external electronic device 102 may be various types of devices, such as a case device capable of storing and charging the electronic device 101.

In the following detailed description, the “state or position in which the electronic device or a designated component of the electronic device faces the user's face” may be mentioned in various manners and it should be noted that this presumes that the user wears the wearable electronic device 200.

According to an embodiment, the wearable electronic device 200 may include a main body portion 201, at least one display member disposed on one surface of the main body portion 201, and wearing members (e.g., temples) connected to the main body portion 201. Depending on the structure of the display member, the wearable electronic device 200 may further include a structure (e.g., lens frame) for mounting or supporting the display member. A pair of display members including a first display member and a second display member may be provided and be disposed to correspond to the user's right and left eyes, respectively, while the wearable electronic device 200 is worn on the user's body. In an embodiment, the wearable electronic device 200 may have a housing shape (e.g., goggles shape) including one display member corresponding to the right eye and the left eye.

According to an embodiment, the display member is a component provided to provide visual information to the user and may include, e.g., a display D, a plurality of lenses L1, L2, L3, and L4 (e.g., a lens assembly), and/or at least one sensor. Here, the lens assembly and the display D each may be formed to be transparent or semi-transparent. However, the display member is not limited thereto. In an embodiment, the display member may include a window member that may be a semi-parent glass or a member capable of adjusting its light transmittance depending on the concentration of coloring. In an embodiment, the display member may include a reflective lens or a lens including a waveguide. An image output from the light output device (e.g., a projector or display D) may form on each lens, providing the user with visual information. For example, the display member may mean a display that may include a waveguide (e.g., a light waveguide) in at least a portion of each lens and transfer the image (or light) output from the light output device, such as the display D, through the waveguide included in the display member to the user's eye while simultaneously transferring the real world through the area to the user's eye in a see-through fashion. In an embodiment, the waveguide may be understood as a portion of a lens assembly. The lens assembly is a component that includes a plurality of lenses (e.g., L1, L2, L3, and L4) and may be disposed in a space within the wearable electronic device 200 to be aligned with the optical axis (e.g., axis I in FIG. 2).

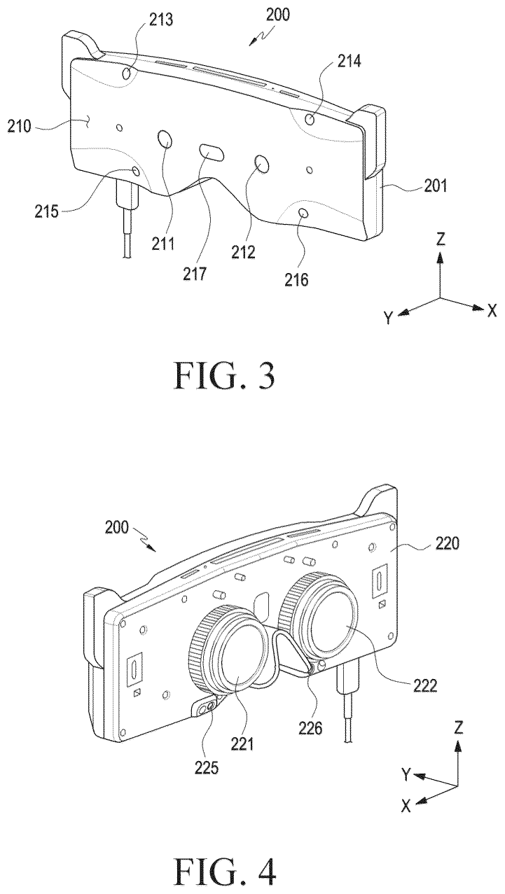

FIG. 3 is a perspective view illustrating a front surface of a wearable electronic device according to an embodiment of the disclosure. FIG. 4 is a perspective view illustrating a rear surface of a wearable electronic device according to an embodiment of the disclosure.

Referring to FIGS. 3 and 4, in an embodiment, camera modules 211, 212, 213, 214, 215, and 216 and/or a depth sensor 217 for obtaining information related to the ambient environment of the wearable electronic device 200 may be disposed on a first surface 210 of a main body portion 201 of a wearable electronic device 200 (e.g., a housing).

In an embodiment, the camera modules 211 and 212 may obtain images related to the ambient environment of the wearable electronic device.

In an embodiment, the camera modules 213, 214, 215, and 216 may obtain images while the wearable electronic device is worn by the user. The camera modules 213, 214, 215, and 216 may be used for hand detection, tracking, and recognition of the user gesture (e.g., hand motion). The camera modules 213, 214, 215, and 216 may be used for 3 degrees of freedom (DoF) or 6 DoF head tracking, location (space or environment) recognition, and/or movement recognition. In an embodiment, the camera modules 211 and 212 may be used for hand detection and tracking or recognition or detection of the user's gesture.

In an embodiment, the depth sensor 217 may be configured to transmit a signal and receive a signal reflected from an object and be used for identifying the distance to the object, such as time of flight (TOF). Alternatively or additionally to the depth sensor 217, the camera modules 213, 214, 215, and 216 may identify the distance to the object.

According to an embodiment, camera modules 225 and 226 and/or lens modules 221 and 222 may be disposed on a second surface 220 of the housing. The camera modules 225 and 226, disposed on the second surface 220 of the housing, may be used to recognize the user's face, or may recognize both eyes of the user (e.g., iris recognition) and/or track (e.g., eye tracking).

In an embodiment, the lens modules 221 and 222 may be disposed on the second surface 220 of the wearable electronic device 200. In an embodiment, the lens modules 221 and 222 may be at least partially similar to or substantially the same as the display D and/or the lenses L1, L2, L3, and L4 of FIG. 2. In an embodiment, the wearable electronic device 200 may not include the camera modules 215 and 216 among the plurality of camera modules 213, 214, 215, and 216. The wearable electronic device 200 may further include at least one of the components shown in FIGS. 1 and/or 2.

As described above, according to an embodiment, the wearable electronic device 200 may have a form factor to be worn on the user's head. The wearable electronic device 200 may further include a strap and/or a wearing member to be fixed on the user's body part. The wearable electronic device 200 may provide the user experience based on augmented reality, virtual reality, and/or mixed reality while worn on the user's head.

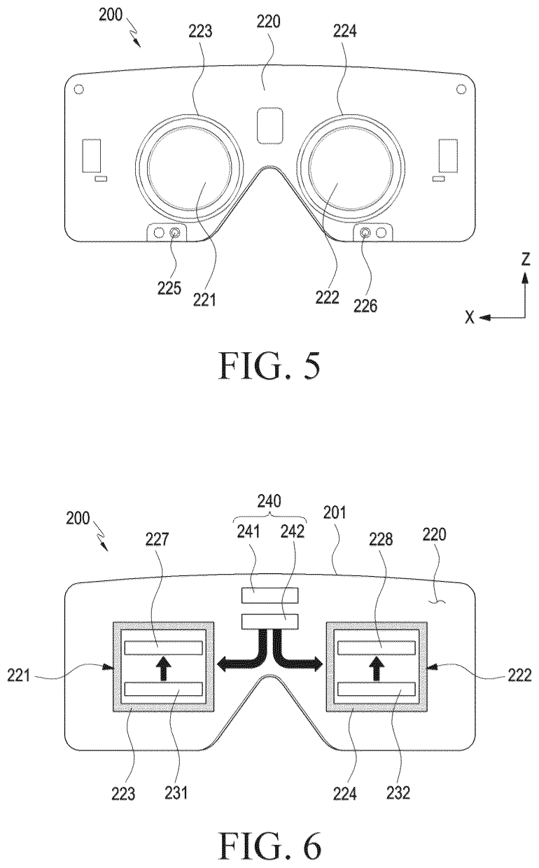

FIG. 5 is a front view illustrating a rear surface of a wearable electronic device according to an embodiment of the disclosure.

Referring to FIG. 5, a wearable electronic device 200 may include a first lens module 221 and a second lens module 222 corresponding to the user's eyes. The first lens module 221 and the second lens module 222 each may include a lens and a barrel structure 223/224 respectively surrounding the lenses. For example, the first lens module 221 may include a lens and a first barrel structure 223. The second lens module 222 may include a lens and a second barrel structure 224. The first barrel structure 223 and the second barrel structure 224 may be disposed on one surface (e.g., the rear surface 220) of the main body portion 201. The first barrel structure 223 and the second barrel structure 224 have, e.g., a cylindrical shape in FIG. 5, but are not necessarily limited thereto. According to an embodiment, when the user wears the wearable electronic device 200, the first barrel structure 223 and the second barrel structure 224 may be disposed at positions surrounding the user's left and right eyes.

The camera modules 225 and 226 track the user's gaze by identifying the corneal areas and pupil areas of the user's eyes based on the amount of change in the amount of light reflected from the user's eye areas, or recognize the user's irises by identifying the iris areas of the user's eyes. According to the embodiment shown in FIG. 5, the camera modules 225 and 226 may be disposed adjacent to the barrel structures 223 and 224, outside of the lens modules 221 and 222.

FIG. 6 is a view illustrating a heat transfer system of a wearable electronic device according to an embodiment of the disclosure. FIG. 6 is a conceptual view illustrating the operation principle of a heat transfer system of the disclosure based on the rear view of the wearable electronic device of FIG. 5.

To prevent or remove fogginess generated in the head-mounted wearable electronic device, a separate heat source (e.g., heater) is provided, and heat from the separate heat source may be transferred to the lens to remove fogginess.

As such, a method for removing or preventing fogginess using a separate heat source may be difficult to apply to electronic devices with a narrow component arrangement space, such as head-mounted wearable electronic devices. Further, as additional power is required in addition to the power required to perform the functions of the head-mounted wearable electronic device to operate the separate heat source, battery capacity may become insufficient.

The wearable electronic device of the disclosure may remove, reduce, and/or prevent fogginess without having a separate heat source.

Objects of the disclosure are not limited to the foregoing, and other unmentioned objects would be apparent to one of ordinary skill in the art.

According to an embodiment, the wearable electronic device 200 may provide a structure for transferring heat from the electronic components 240 disposed in the main body portion 201 toward the lenses 227 and 228 included in the lens modules 221 and 222. Various lens modules may be applied as the lens modules 221 and 222. For example, the lens module may include one of a pancake lens, a Fresnel lens, and a multi-channel lens, as well as a general convex and/or concave lens. Various electronic components 240 such as a battery 241, a power management device, memory, and a processor 242 may be disposed in the main body portion 201. The wearable electronic device 200 may provide a structure for transferring heat from the processor 242 (e.g., an application processor), which is a component generating the most heat among the electronic components 240 disposed in the main body portion 201, toward the lenses 227 and 228.

According to an embodiment, the wearable electronic device 200 may provide a structure for transferring heat from the electronic components disposed inside the lens modules 221 and 222 toward the lenses 227 and 228. For example, the wearable electronic device 200 may provide a structure for transferring heat from the displays 231 and 232 disposed inside the lens modules 221 and 222 toward the lenses 227 and 228. Here, the displays 231 and 232 may include a first display 231 corresponding to the first lens module 221 and a second display 232 corresponding to the second lens module 222. Each of the first display 231 and the second display 232 may output visual information. The displays 231 and 232 include at least one of a liquid crystal display (LCD), a digital mirror device (DMD), a liquid crystal on silicon (LCoS), a light emitting diode (LED) on silicon (LEDoS), an organic light emitting diode (OLED), or a micro light emitting diode (micro LED).

According to an embodiment, the wearable electronic device 200 may include a structure for transferring heat toward the lenses 227 and 228 from the processor 242 (e.g., an application processor), which is a component generating the most heat among the electronic components disposed in the main body portion 201, and a structure for transferring heat toward the lenses 227 and 228 from the displays 231 and 232 disposed inside the lens modules 221 and 222, and may receive heat selectively from them or from both of them, thereby effectively removing, reducing, and/or preventing fogginess.

In the disclosure, as a structure for transferring heat toward the lenses 227 and 228, the barrel structures 223 and 224 including a heat conductive material may be provided.

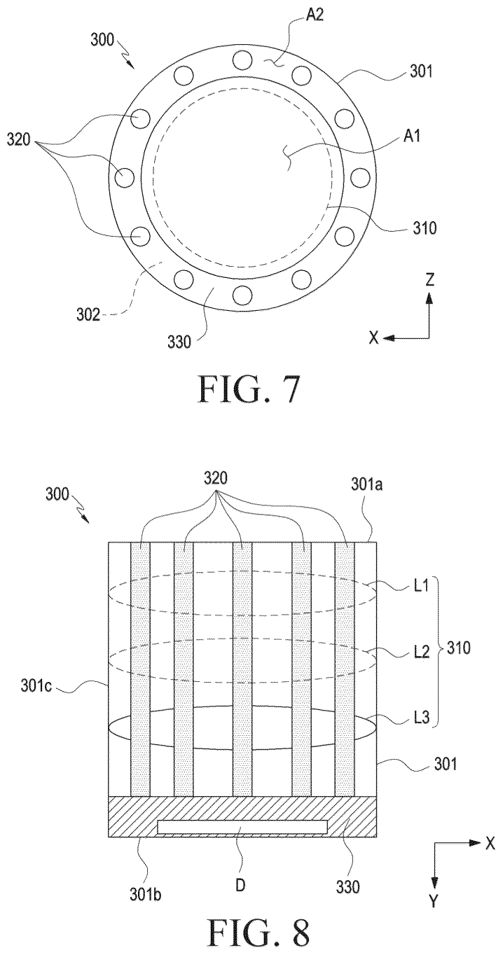

Hereinafter, the barrel structures 223 and 224 for effectively removing, reducing, and/or preventing fogginess are described in detail with reference to FIGS. 7 to 13.

FIG. 7 is a view illustrating a rear surface of a lens module according to an embodiment of the disclosure. FIG. 8 is a view illustrating a side surface of a lens module according to an embodiment of the disclosure.

The lens module 300 (e.g., the lens modules 221 and 222 of FIGS. 2 to 6) may include two lens modules corresponding to the user's eyes. According to an embodiment, the lens module 300 may include a first lens module corresponding to the user's left eye EL and a second lens module corresponding to the user's right eye ER. The first lens module and the second lens module may be substantially identical in configuration except that they correspond to the left eye EL and the right eye ER of the user, respectively. Therefore, for convenience, the description is made with reference to one lens module of the first lens module and the second lens module as illustrated in the drawings.

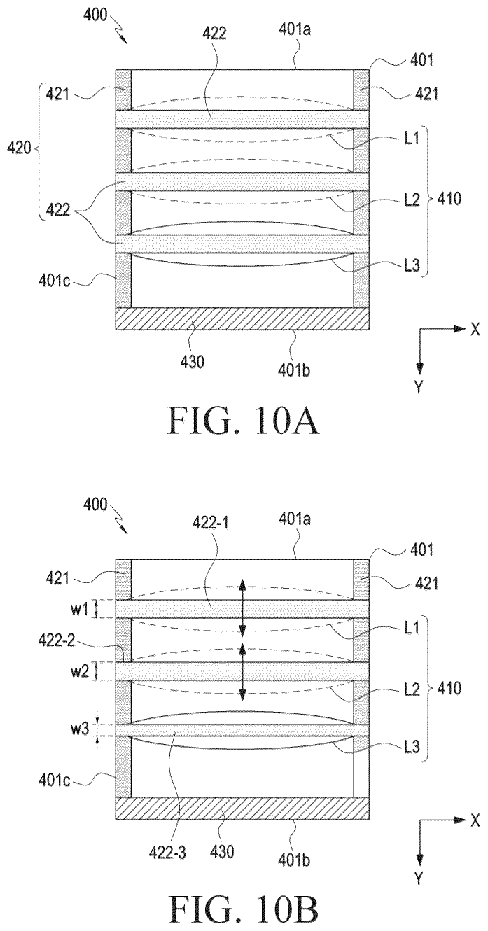

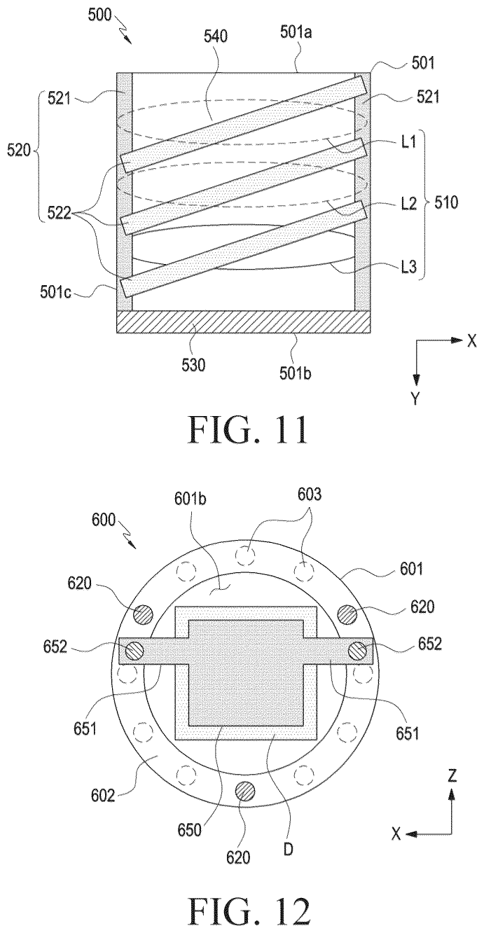

The lens module 300 may include a lens 310 (e.g., the lens 227 or 228 of FIG. 6) and a barrel structure 301 (e.g., the barrel structure 223 or 224 of FIGS. 2 to 6) surrounding the lens 310. As described above with reference to FIG. 6, as the lens 310, one of a pancake lens, a Fresnel lens, and a multi-channel lens, as well as a general convex and/or concave lens, may be adopted. The lens 310 may be configured as a plurality of lenses, and in this case, the number of lenses is not limited. In FIG. 8 and other subsequent figures (e.g., FIGS. 10A, 10B, and 11), three lenses L1, L2, and L3 are illustrated as an example, but more or fewer lenses may be included. The barrel structure 301 may include a first surface 301a facing in a direction substantially parallel to a rear surface (e.g., the rear surface 220 of FIGS. 2 to 6) of a wearable electronic device (e.g., the wearable electronic device 200 of FIGS. 2 to 6), and a second surface 301b facing in a direction substantially opposite to the first surface 301a. It may further include a third surface 301c surrounding a space between the first surface 301a and the second surface 301b. The third surface 301c may be substantially perpendicular to the first surface 301a and/or the second surface 301b, but is not necessarily limited thereto. The barrel structure 301 is illustrated as having a completely circular shape when viewed from the top/bottom (e.g., in the Y-axis direction) (see FIG. 7) and a rectangular cross-sectional shape when viewed from the side (e.g., in the Z-axis direction) (see FIG. 8), but this is not necessarily the case but the specific shape may vary depending on embodiments.

The barrel structure 301 may include a barrel 302 surrounding the lens and a barrel cover 330 disposed on a rear surface of the barrel 302. Referring to FIG. 7, the lens module 300 may be divided into an area A1 in which the lens 310 is disposed and an area A2 surrounding the lens 310. According to an embodiment, the barrel 302 may be disposed in the area A2 surrounding the lens 310 (e.g., L1, L2, and L3), and the barrel cover 330 may have a shape that covers both the area A2 surrounding the lens 310 and the area A1 in which the lens 3100 is disposed on the rear surface of the barrel 302.

Referring to FIG. 8, according to an embodiment, the barrel cover 330 may surround at least a portion of the display D (e.g., the displays 231 and 232 of FIG. 6). As the wearable electronic device according to the disclosure, an embodiment in which the display D is mounted on the barrel cover 330, i.e., a video see through (VST) device may be applied. The VST device may include, e.g., a wearable electronic device of a virtual reality (VR) type, a mixed reality (MR) type in which augmented reality (AR) and virtual reality (VR) are mixed, or an eXtended reality (XR) type.

According to the disclosure, the barrel structure 301 may include a heat conductive material 320 as a component for removing, reducing, and/or preventing fogginess. The heat conductive material 320 may be a material having high thermal conductivity indicating “how much heat is transferred within a specific time according to a specific temperature difference by a material having a unit thickness per unit area.” For example, as long as the thermal conductivity of the disclosure is high, not only metals such as copper and gold, but also synthetic resins and/or various compounds may be applied as the heat conductive material 320 of the disclosure, and the heat conductive material 320 is not limited to any specific embodiment. For example, a synthetic resin having high thermal conductivity may be applied as the heat conductive material 320, and the heat conductive material 320 using the same may be formed by double injection molding when manufacturing the barrel 302 of the barrel structure 301.

Referring to FIGS. 7 and 8 together, according to an embodiment, the heat conductive material 320 may be formed at a plurality of positions in the area A2 surrounding the lens 310 in which the barrel 302 is disposed. Further, the heat conductive material 320 may extend in the first direction. For example, the heat conductive material 320 may extend from the first surface 301a of the barrel structure 301 toward the second surface 301b. For example, the heat conductive material 320 may extend from the first surface 301a of the barrel structure 301 toward the second surface 301b and then contact the barrel cover 330. According to an embodiment, the first direction may mean the height direction (e.g., the Y-axis direction) of the barrel structure 301, but is not necessarily limited thereto. For example, the first direction may mean a direction that is substantially parallel to the height direction (e.g., the Y-axis direction) of the barrel structure 301 but inclined by a predetermined angle. If the first direction is the same as the height direction (e.g., the Y-axis direction) of the barrel structure 301, e.g., the barrel 302 may have a shape similar to that of the cylinder of a revolver, and the heat conductive material 320 may be disposed in a recess formed in the barrel 302. If the first direction is inclined at a predetermined angle from the height direction (e.g., the Y-axis direction) of the barrel structure 301, the heat conductive material 320 may have a spiral shape along the barrel 302 of the barrel structure 301. As such, the placement of the heat conductive material 320 may vary.

The heat conductive material 320 may extend in the first direction and may extend to positions corresponding to the plurality of lenses. For example, the lens module 300 may include a plurality of lenses (e.g., L1, L2, and L3) spaced apart from each other at predetermined intervals along the height direction (e.g., the Y-axis direction) of the barrel structure 301. In this case, fogginess may occur in at least one of the plurality of lenses. Accordingly, the heat conductive material 320 of the disclosure may extend to positions corresponding to the plurality of lenses L1, L2, and L3 to remove and/or prevent fogginess occurring in at least any one lens. For example, the heat conductive material 320 may extend in the height direction of the barrel structure to correspond to the plurality of lenses.

The heat conductive material 320 may be thermally connected to at least one heat source. Here, the at least one heat source may be, e.g., the display D or the processor as described above with reference to FIG. 6. Here, when an element is “thermally connected” to another element, it may mean that heat is reversibly moved from a relatively hot element to a cold element. In this case, a certain component and another component may be thermally connected when they are in direct physical contact with each other, but may also be thermally connected even when they are not in direct contact with each other as another element (e.g., an intermediate medium) is disposed therebetween (i.e., indirect contact). Referring to FIG. 8, the heat conductive material 320 may be thermally connected to the display D. In this case, the heat conductive material 320 and the display D may not be in direct contact with each other, and the barrel cover 330 may be disposed between the heat conductive material 320 and the display D. When the heat conductive material 320 is thermally connected to at least one heat source (e.g., the display D), it may encompass that the heat conductive material 320 is thermally connected to the intermediate medium (e.g., the barrel cover 330), and the intermediate medium (e.g., the barrel cover 330) and at least one heat source (e.g., the display D) are thermally connected to each other.

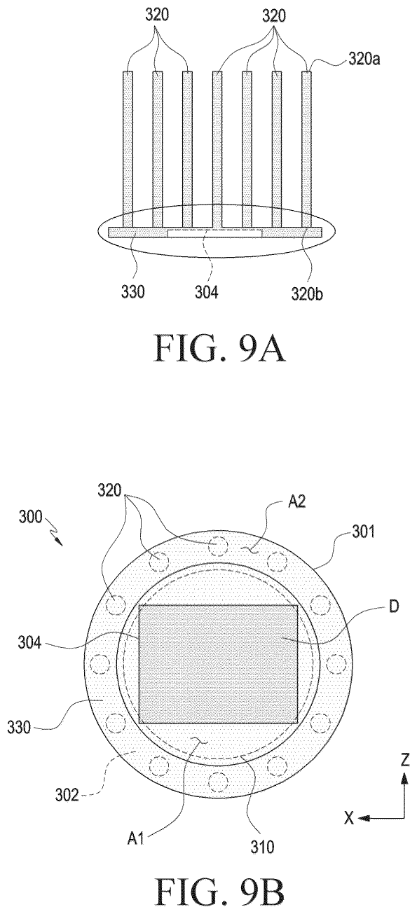

FIG. 9A is a view illustrating a state in which a barrel is removed from a lens module according to an embodiment of the disclosure. FIG. 9B is a view illustrating a lens module having a display mounted thereon according to an embodiment of the disclosure.

Referring to FIG. 9A, the heat conductive material 320 may include one end portion 320a and the other end portion 320b, and may be connected to the barrel cover 330 at the other end portion 320b. According to an embodiment, the heat conductive material 320 may be connected to the barrel cover 330, and they may be formed of materials having different thermal conductivity values. According to an embodiment, the heat conductive material 320 may be formed of the same material as the barrel cover 330. According to another embodiment, the heat conductive material 320 may be formed substantially integrally with the barrel cover 330 (one-body).

Referring to FIGS. 9A and 9B together, a display seating portion 304 where a display is disposed may be formed on the barrel cover 330. According to an embodiment, the display seating portion 304 may be formed in the form of a groove recessed inward from the surface of the barrel cover 330 in the barrel cover 330. When the display D is seated on the display seating portion 304, heat generated from the display D may be transferred to the heat conductive material 320 through the barrel cover 330. When the heat conductive material 320 and the barrel cover 330 are formed of the same material, heat generated from the display D may be transferred to the heat conductive material 320 in a state in which heat loss is minimized. The heat transferred to the heat conductive material 320 may remove the fogginess generated in the lens 310 adjacent to the heat conductive material 320 or prevent fogginess.

FIG. 10A is a view illustrating an arrangement form of a lens module and a thermal conductive material according to an embodiment of the disclosure. FIG. 10B is a view illustrating an arrangement form of a lens module and a thermal conductive material according to an embodiment of the disclosure.

The heat conductive material may have diversified forms. For example, in the embodiments of FIGS. 7 and 8, the diversity in the first direction in which the heat conductive material extends has been described above. In the embodiments of FIGS. 10A and 10B, other various forms of the heat conductive material may be disclosed under the assumption that the first direction matches the height direction of the barrel structure 301.

Referring to FIG. 10A, the lens module 400 may include a lens 410 (e.g., the lens 227 or 228 of FIG. 6 or the lens 310 of FIGS. 7 to 9B) and a barrel structure 401 (e.g., the barrel structure 223 or 224 of FIGS. 2 to 6 or the barrel structure 301 of FIGS. 7 to 9B) surrounding the lens 410. The barrel structure 401 may include a first surface 401a facing in a direction substantially parallel to a rear surface (e.g., the rear surface 220 of FIGS. 2 to 6) of a wearable electronic device (e.g., the wearable electronic device 200 of FIGS. 2 to 6), and a second surface 401b facing in a direction substantially opposite to the first surface 401a. It may further include a third surface 401c surrounding a space between the first surface 401a and the second surface 401b. The third surface 401c may be substantially perpendicular to the first surface 401a and/or the second surface 401b, respectively, but is not necessarily limited thereto. The barrel structure 401 may include a barrel, a barrel cover 430, and a heat conductive material 420.

The heat conductive material 420 may include a first heat conductive portion 421 extending in the first direction and a second heat conductive portion 422 thermally connected to the heat conductive portion (e.g., the first heat conductive portion 421) and extending in a second direction different from the first direction. According to an embodiment, the first heat conductive portion 421 may be a portion extending in the height direction (e.g., the Y-axis direction) of the barrel structure 401 to correspond to the plurality of lenses (e.g., L1, L2, and L3). The second heat conductive portion 422 may be thermally connected to the first heat conductive portion 421 and may extend in a second direction different from the height direction of the barrel structure 401 to correspond to each of the plurality of lenses (e.g., L1, L2, and L3). According to an embodiment, in the first heat conductive portion 421, the heat conductive material may extend from the first surface 401a of the barrel structure 401 toward the second surface 401b, and the first heat conductive portion 421 may include a plurality of first heat conductive portions 421. The second heat conductive portion 422 is disposed in the form of a ring surrounding the lens 410 when the heat conductive material is viewed from above or below (e.g., in the Y-axis direction) (see FIG. 9B), and the second heat conductive portion 422 may include a plurality of second heat conductive portions 422. The first heat conductive portion 421 may serve to move (or raise) the heat transferred to the barrel cover 430 along the height direction (e.g., the Y-axis direction) of the barrel structure 401, and the second heat conductive portion 422 may serve to disperse the heat transferred to the first heat conductive portion 421 around the lens 410. Since the second heat conductive portion 422 is disposed to be spaced apart from the barrel cover 430 by a predetermined distance in the height direction (e.g., the Y-axis direction) of the barrel structure 401, at least a portion thereof may contact the first heat conductive portion 421 to receive heat.

According to an embodiment, some of the plurality of lenses included in the lens module 400 may be configured to be movable inside the barrel structure 401 for diopter adjustment. For example, referring to FIG. 10B, some lenses (e.g., the first lens L1 and the second lens L2) among the plurality of lenses (e.g., L1, L2, and L3) may be configured to be movable along the height direction of the barrel structure 401 inside the barrel structure 401. The other lens (e.g., the third lens L3) may be fixed in the barrel structure 401. The second heat conductive portion 422 may include second heat conductive portions 422-1, 422-2, and 422-3 corresponding to a plurality of lenses (e.g., L1, L2, and L3). The thicknesses W1 and W2 of the second heat conductive portions (e.g., 422-1 and 422-2) corresponding to the lenses (e.g., the first lens L1 and the second lens L2) configured to be movable may be greater than the thickness W3 of the second heat conductive portion 422-3 corresponding to the lens (e.g., the third lens L3) having the fixed position. The lenses (e.g., the first lens L1 and the second lens L2) configured to be movable may have a wider range of fogginess or range in which fogginess may occur, as formed around, than the position-fixed lens (e.g., the third lens L3). Accordingly, the second heat conductive portions (e.g., 422-1 and 422-2) corresponding to the lenses (e.g., the first lens L1 and the second lens L2) configured to be movable may be formed to have a thickness greater than that of the second heat conductive portion (e.g., 422-3) corresponding to the position-fixed lens, thereby more effectively removing and/or preventing fogginess.

FIG. 11 is a view illustrating an arrangement form of a lens module and a thermal conductive material according to an embodiment of the disclosure.

Referring to FIG. 11, a lens module 500 may include a lens 510 (e.g., the lens 227 or 228 of FIG. 6, the lens 310 of FIGS. 7 to 9B, the lens 410 of FIGS. 10A and 10B), and a barrel structure 501 (e.g., the barrel structure 223 or 224 of FIGS. 2 to 6, the barrel structure 301 of FIGS. 7 to 9B, and the barrel structure 401 of FIGS. 10A and 10B) surrounding the lens 510. The barrel structure 501 may include a first surface 501a facing in a direction substantially parallel to a rear surface (e.g., the rear surface 220 of FIGS. 2 to 6) of a wearable electronic device (e.g., the wearable electronic device 200 of FIGS. 2 to 6), and a second surface 501b facing in a direction substantially opposite to the first surface 501a. The electronic device may further include a third surface 501c surrounding a space between the first surface 501a and the second surface 501b. The third surface 501c may be substantially perpendicular to each of the first surface 501a and/or the second surface 501b, but is not necessarily limited thereto. The barrel structure 501 may include a barrel, a barrel cover 530, and a heat conductive material 520.

Referring to FIG. 11, the heat conductive material 520 may include a first heat conductive portion 521 and a second heat conductive portion 522 formed to be inclined with respect to the width direction (e.g., the X-axis direction) of the barrel structure 501, as the second heat conductive portion 522. The lens 510 included in the lens module 500 may typically be disposed parallel to the width direction of the barrel structure 501. In other words, according to an embodiment, the second heat conductive portion 522 may be formed to surround the lens 510 in a state of being inclined with respect to the lens 510 at a predetermined angle, not in a state of being parallel to the lens 510. The embodiment of FIG. 11 is various examples of the arrangement form of the heat conductive material 520, and may be combined with the above-described embodiment (e.g., the embodiment illustrated in FIGS. 10A and 10B) or may be selectively applied.

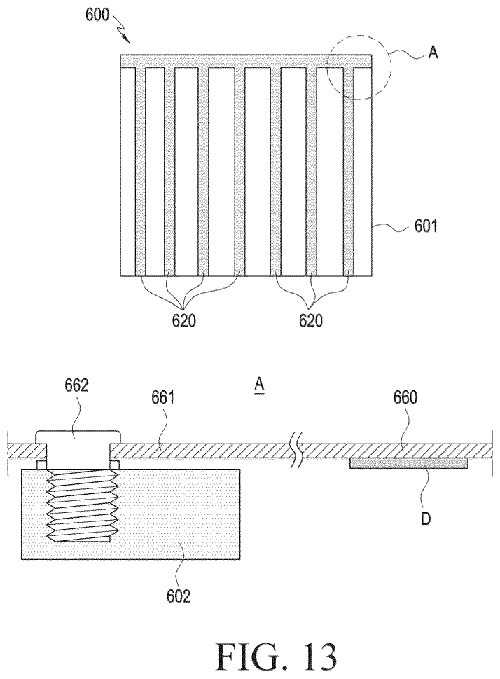

FIG. 12 is a view illustrating a lens module having a display further including a heat dissipation plate mounted thereon according to an embodiment of the disclosure. FIG. 13 is a view illustrating a coupling relationship between a printed circuit board and a thermal conductive material according to an embodiment of the disclosure.

Referring to FIG. 12, a lens module 600 may include a lens (e.g., the lens 227 or 228 of FIG. 6, the lens 310 of FIGS. 7 to 9B, the lens 410 of FIGS. 10A and 10B, or the lens 510 of FIG. 11) and a barrel structure 601 (e.g., the barrel structure 223 or 224 of FIGS. 2 to 6, the barrel structure 301 of FIGS. 7 to 9B, the barrel structure 401 of FIGS. 10A and 10B, or the barrel structure 501 of FIG. 11) surrounding the lens. The barrel structure 601 may include a first surface facing in a direction substantially parallel to a rear surface (e.g., the rear surface 220 of FIGS. 2 to 6) of a wearable electronic device (e.g., the wearable electronic device 200 of FIGS. 2 to 6), and a second surface 601b facing in a direction substantially opposite to the first surface. A third surface surrounding a space between the first surface and the second surface 601b may be included. The barrel structure 601 may include a barrel 602 and a heat conductive material 620. The heat conductive material 620 may be disposed in the whole or part of the recess 603 provided in the barrel 602.

The lens module 600 may further include a heat dissipation plate 650 for transferring heat from at least one heat source to the barrel structure 601. According to an embodiment, the heat dissipation plate 650 may be provided for a smooth thermal connection to the lens module 600 when the barrel cover is not provided or the heat transfer material 620 does not contact the barrel cover. The heat dissipation plate 650 may be disposed adjacent to at least one heat source (e.g., the display D). According to an embodiment, the heat dissipation plate 650 may transfer heat of at least one heat source (e.g., the display D) to the barrel 602 and/or the heat transfer material 620 through a fastening member 652. According to an embodiment, the fastening member 652 and the heat dissipation plate 650 may be connected to each other through a bridge 651.

Referring to FIG. 13, at least one heat source (e.g., the display D) may be disposed on one surface of a printed circuit board 660. For example, at least one heat source (e.g., the display D) may be disposed on the printed circuit board 660 disposed outside the lens module 600. According to an embodiment, the printed circuit board 660 may transfer heat of at least one heat source (e.g., the display D) to the barrel 602 and/or the barrel cover through the fastening member 662 (e.g., the fastening member 652 of FIG. 12). According to an embodiment, the fastening member 662 and the printed circuit board 660 may be connected to each other through the bridge 661 (e.g., the bridge 651 of FIG. 12).

According to an embodiment, the fastening members 652 and 662 described with reference to FIGS. 12 and 13 may be fixed screws, and portions where the fastening members 652 and 662 are fastened may be barrel fixing screw holes formed in the barrel 602 or the barrel cover.

According to the embodiment illustrated in FIGS. 12 and 13, in the case where the barrel cover is not provided or, although the barrel cover is provided, the heat source and the heat conductive material are spaced apart from each other by a distance, the thermal connection may be implemented using the fastening member, and fogginess occurring in the lens may be removed and/or prevented.

The electronic device according to one or more embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. The electronic devices according to an embodiment are not limited to those described above.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program) including one or more instructions that are stored in a storage medium (e.g., internal memory 136 or external memory 138) that is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiment(s) of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Effects obtainable from the disclosure are not limited to the above-mentioned effects, and other effects not mentioned may be apparent to one of ordinary skill in the art.

While the disclosure has been described and shown in connection with one or more embodiments thereof, it should be appreciated that disclosed embodiments are not intended as limiting, but rather as illustrative. It will be apparent to one of ordinary skill in the art that various changes may be made in form and detail without departing from the overall scope of the disclosure, including the appended claims and their equivalents.

What is claimed is:

1. A wearable electronic device comprising:
a main body portion;
a lens module comprising a lens and a barrel structure, wherein the barrel structure surrounds the lens and is on one surface of the main body portion; and
at least one heat source,
wherein the barrel structure comprises a thermal conductive material thermally connected to the at least one heat source and at least partially extending in a first direction, and
wherein the thermal conductive material is configured to transfer heat from the at least one heat source to the lens.

2. The wearable electronic device of claim 1,
wherein the wearable electronic device comprises a video see through device.

3. The wearable electronic device of claim 1,
wherein the thermal conductive material is formed by a double injection process with respect to the barrel structure.

4. The wearable electronic device of claim 1,
wherein the lens module comprises a plurality of lenses spaced apart from each other at predetermined intervals along a height direction of the barrel structure, and
wherein the thermal conductive material comprises a first heat conductive portion extending in the height direction of the barrel structure and configured to transfer the heat to the plurality of lenses.

5. The wearable electronic device of claim 4,
wherein the thermal conductive material further comprises a plurality of second heat conductive portions thermally connected to the first heat conductive portion, wherein the plurality of second heat conductive portions extend in a second direction different from the height direction of the barrel structure and are configured to transfer the heat to the plurality of lenses.

6. The wearable electronic device of claim 5,
wherein the plurality of second heat conductive portions are disposed along a circumference of the barrel structure.

7. The wearable electronic device of claim 5,
wherein the plurality of second heat conductive portions are inclined with respect to a width direction of the barrel structure.

8. The wearable electronic device of claim 5,
wherein the plurality of lenses comprises:
a lens movable in the barrel structure and configured to adjust a diopter; and
a fixed lens comprising a fixed position,
wherein the plurality of second heat conductive portions comprises a second heat conducting portion corresponding to the movable lens and a second heat conducting portion corresponding to the fixed lens, and
wherein the second heat conductive portion corresponding to the movable lens comprises a thickness greater than a thickness of the second heat conductive portion corresponding to the fixed lens.

9. The wearable electronic device of claim 1,
wherein the at least one heat source comprises at least one of a heat source inside the lens module or a heat source in the main body portion outside the lens module.

10. The wearable electronic device of claim 1,
wherein the at least one heat source comprises a display and a processor in the main body portion.

11. The wearable electronic device of claim 1,
wherein the thermal conductive material is thermally connected to a plurality of heat sources.

12. The wearable electronic device of claim 10,
wherein the barrel structure comprises a barrel and a barrel cover on a rear surface of the barrel.

13. The wearable electronic device of claim 12, wherein the barrel cover comprises a display seating portion where the display is seated.

14. The wearable electronic device of claim 1, further comprising:
a heat dissipation plate adjacent to the at least one heat source and configured to transfer the heat from the at least one heat source to the barrel structure.

15. The wearable electronic device of claim 1, further comprising a printed circuit board,
wherein the at least one heat source is on a surface of the printed circuit board, and
wherein the heat is transferred to the barrel structure through a fastening member connected to a fastening hole formed in the barrel structure.

16. A wearable electronic device comprising:
a main body portion;
a lens module comprising:
a plurality of lenses; and
a barrel structure, wherein the barrel structure surrounds the plurality of lenses and is on one surface of the main body portion; and
at least one heat source,
wherein the barrel structure comprises a thermal conductive material thermally connected to the at least one heat source and configured to transfer heat from the at least one heat source to the plurality of lenses, and
wherein the thermal conductive material comprises a first heat conductive portion extending in a first direction and a second heat conductive portion thermally connected to the first heat conductive portion and extending in a second direction different from the first direction.

17. The wearable electronic device of claim 16,
wherein the wearable electronic device comprises a video see through device.

18. The wearable electronic device of claim 16,
wherein the first heat conductive portion comprises a shape extending in the first direction to correspond to at least two lenses among the plurality of lenses, and
wherein the second heat conductive portion comprises a plurality of second heat conductive portions extending in the second direction from the first heat conductive portion, wherein each of the plurality of second heat conductive portions corresponds to a lens of the plurality of lenses.

19. The wearable electronic device of claim 18,
wherein a lens of the plurality of lenses is configured to be movable in the barrel structure and to adjust a diopter,
wherein the plurality of second heat conductive portions comprises a second heat conductive portion corresponding to the lens that is configured to be moveable and a second heat conductive portion corresponding to a lens of the plurality of lenses with a fixed position, and
wherein a thickness of the second heat conductive portion corresponding to the lens that is configured to be moveable is greater than a thickness of the second heat conductive portion corresponding to the lens with the fixed position.

20. The wearable electronic device of claim 16,
wherein the at least one heat source comprises at least one of a heat source inside the lens module or a heat source in the main body portion outside the lens module.
